(19) United States
(12) Patent Application Publication
(10) Pub. No.: US 2024/0377993 A1
(43) Pub. Date: Nov. 14, 2024

(54) JOB EXECUTION SERVICE SYSTEM, NON-TRANSITORY COMPUTER READABLE MEDIUM STORING PROGRAM, AND JOB EXECUTION SERVICE METHOD

(71) Applicant: FUJIFILM Business Innovation Corp., Tokyo (JP)

(72) Inventor: Hirofumi OGAWA, Kanagawa (JP)

(73) Assignee: FUJIFILM Business Innovation Corp., Tokyo (JP)

(21) Appl. No.: 18/504,156

(22) Filed: Nov. 8, 2023

(30) Foreign Application Priority Data
May 8, 2023 (JP) 2023-076624

(51) Int. Cl. G06F 3/12

(52) U.S. Cl. CPC G06F 3/1204; G06F 3/1254; G06F 3/1288; G06F 3/1292

(57) ABSTRACT

A job execution service system includes a cloud side processor that is connected to each of an information processing apparatus and a job execution apparatus, which is installed in a local area as wireless network equipment having a wireless communication function based on a predetermined wireless communication system, via the Internet and that is configured to perform relay of a job sent from the information processing apparatus to the job execution apparatus in a case where a cloud service is provided, in which the cloud side processor selects relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area, provides equipment identification information necessary for wireless connection with the relay equipment to the execution request source and the execution destination of the job, and instruct the relay equipment to perform the relay of the job from the execution request source to the execution destination of the job instead of performing the relay of the job by the cloud side processor.

### CROSS-REFERENCE TO RELATED APPLICATIONS

This application is based on and claims priority under 35 USC 119 from Japanese Patent Application No. 2023-076624 filed May 8, 2023.

### BACKGROUND

### (i) Technical Field

The present invention relates to a job execution service system, a non-transitory computer readable medium storing a program, and a job execution service method.

### (ii) Related Art

Cloud computing is a usage form in which computer resources are provided in a form of services via a computer network such as the Internet. In general, cloud computing is often referred to as “cloud” for short. Cloud provides a printing service called cloud printing. Cloud printing service is a service that enables printing from a terminal such as a PC that can be connected to the cloud via a network such as the Internet with a printer connected to the network. A user does not need to install a device driver for the printer and does not need to perform maintenance on the printer.

In a case where the user uses the cloud printing service, a print job is transmitted from a user terminal to the printer via the Internet and cloud.

As described above, in cloud printing, since the print job is sent to the printer via the Internet, for example, in a case where printers connected to the same local area network (LAN) are used, print jobs, which are sent from terminals, tend to take a long time to finish printing as compared to be sent to the printer via LAN, considering a communication speed of the network or the like.

Therefore, in the related art, even in a case where cloud printing is used, a technique for executing printing by sending a print job to a printer via a LAN instead of the Internet has been proposed (for example, JP2016-066266A).

### SUMMARY

In recent years, an environment shift has begun in which local area information networks are abolished from local areas for security reasons or the like. In a case where cloud provides a cloud service for relaying a job of an information processing apparatus in a local area and causing a job execution apparatus in the same local area to execute the job, and in a case where a local area information network is abolished, the Job cannot be executed via the local area information network instead of via cloud.

Aspects of non-limiting embodiments of the present disclosure relate to a job execution service system, a non-transitory computer readable medium storing a program, and a job execution service method that is capable of, in a case where cloud provides a cloud service for relaying a job of an information processing apparatus in a local area and causing a job execution apparatus in the same local area to execute the job, quickly finishing the job without using a local area information network as compared with a case where the job is executed via the cloud.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a job execution service system including: a cloud side processor that is connected to each of an information processing apparatus and a job execution apparatus, which is installed in a local area as wireless network equipment having a wireless communication function based on a predetermined wireless communication system, via the Internet and that is configured to perform relay of a job sent from the information processing apparatus to the job execution apparatus in a case where a cloud service is provided, in which the cloud side processor is configured to: select relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area; provide equipment identification information necessary for wireless connection with the relay equipment to the execution request source and the execution destination of the job; and instruct the relay equipment to perform the relay of the job from the execution request source to the execution destination of the job instead of performing the relay of the job by the cloud side processor.

### BRIEF DESCRIPTION OF THE DRAWINGS

Exemplary embodiment(s) of the present invention will be described in detail based on the following figures, wherein:

FIG. 1 is an overall configuration diagram showing an exemplary embodiment of a job execution service system according to the exemplary embodiment of the present invention;

FIG. 2 is a functional block configuration diagram of a cloud printing service system according to the present exemplary embodiment;

FIG. 3 is a sequence diagram showing communicable list generation processing according to the present exemplary embodiment;

FIG. 4 is a diagram schematically showing the communicable list generation processing in the present exemplary embodiment;

FIG. 5A is a sequence diagram showing a cloud printing processing according to the present exemplary embodiment;

FIG. 5B is a sequence diagram following FIG. 5A;

FIG. 5C is a sequence diagram following FIG. 5B;

FIG. 6 is a diagram showing another setting example of a communicable list in the present exemplary embodiment;

FIG. 7 is a conceptual diagram schematically showing a case where a print job is relayed by a plurality of relay equipment in the present exemplary embodiment; and

FIG. 8 is a diagram showing another data configuration example of the communicable list in the present exemplary embodiment.

### DETAILED DESCRIPTION

Hereinafter, an exemplary embodiment of the present invention will be described in detail with reference to the accompanying drawings.

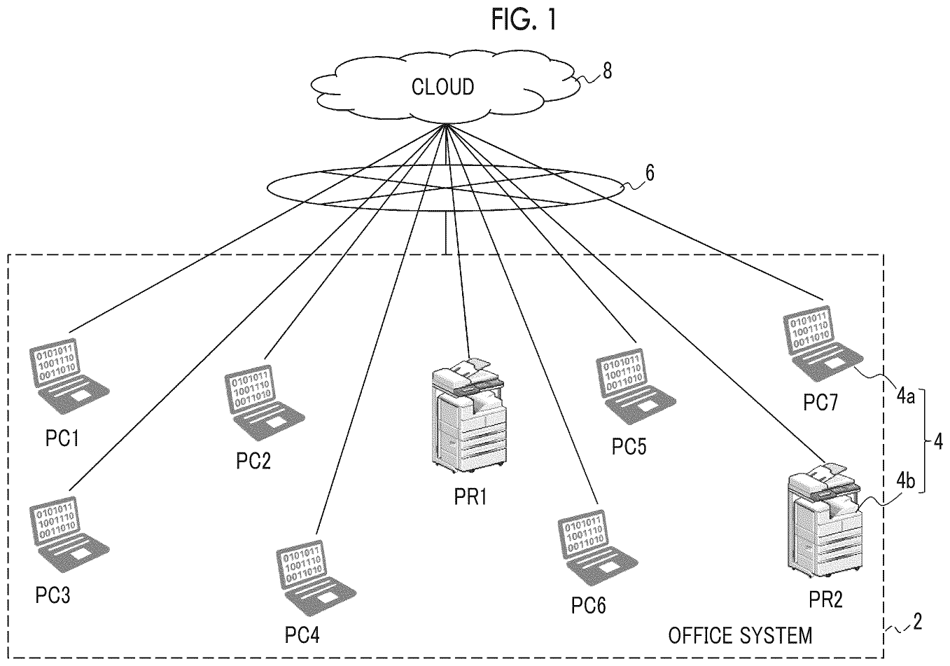

FIG. 1 is an overall configuration diagram showing an exemplary embodiment of a job execution service system according to the exemplary embodiment of the present invention. FIG. 1 shows an office system 2, wireless network equipment 4 included in the office system 2, and a cloud 8 connecting the wireless network equipment 4 via the Internet 6. The office system 2 is a network system built in a local area of a certain office. In the present exemplary embodiment, a cloud printing service is described as an example, as a cloud service provided by the cloud 8. Therefore, a job execution service in the present exemplary embodiment is a cloud printing service for executing a print job.

FIG. 1 shows a user terminal 4a and a printer 4b as the wireless network equipment 4 installed in the office. A unique name is assigned to each of the wireless network equipment 4. In the case of the present exemplary embodiment, since the user terminal 4a is exemplified by using a personal computer (PC), a name PCi (i=1 to n, n is a natural number) is assigned for the user terminal 4a, and a name PRj (j=1 to m, m is a natural number) is assigned to the printer 4b. FIG. 1 only shows that plurality of wireless network equipment 4 are installed in the office in a scattered manner, and the number and positions of the wireless network equipment 4 are not limited to FIG. 1.

The user terminal 4a is an information processing apparatus used by a user and will be described as being implemented by a PC as described above in the present exemplary embodiment. The user terminal 4a can be implemented with a general-purpose hardware configuration, such as a PC, which exists from the related art. That is, the user terminal 4a includes a CPU, a ROM, a RAM, a hard disk drive (HDD) as a memory, a user interface, which includes an input unit such as a mouse or a keyboard, and a display unit such as a display, and a network interface as a communicator for performing network communication via the Internet 6 in order to use the cloud service or the like. Further, in the user terminal 4a in the present exemplary embodiment, an access point having a wireless communication function based on WiFi (registered trademark) as a predetermined wireless communication system is mounted. The access point is a device for performing wireless communication with other wireless network equipment 4 positioned within a predetermined communication range in the office. As described above, in the present exemplary embodiment, although a PC is used as the user terminal 4a as an example, an information processing apparatus other than a PC, such as a tablet terminal, may be used as long as an access point is mounted and a function of causing the printer 4b to execute the print job is included.

The printer 4b is a printing apparatus having a printing function and can be implemented by an image forming apparatus such as a multifunction machine, for example, in the present exemplary embodiment. The printer 4b can be implemented by using a general-purpose apparatus configuration incorporating a computer. That is, the printer 4b includes a CPU, a ROM, a RAM, a hard disk drive (HDD) as a memory, an operation panel as a user interface, and a printer. Further, the printer 4b in the present exemplary embodiment includes a network interface for performing network communication via the Internet 6 similar to the user terminal 4a as the communicator, and an access point for performing wireless communication based on WiFi with other wireless network equipment 4 positioned within the predetermined communication range in the office.

By the way, a LAN is not installed as a local area information network in the office system 2. A LAN may be installed, but in a case where cloud printing is used as described later, a LAN is not used. Although WiFi or an access point based on WiFi may be interpreted as synonymous with wireless LAN, in the present exemplary embodiment, a LAN built by installing a wireless communicator such as a wired communication cable or a router in the local area is treated as different from a wireless network that uses wireless communication using an access point. Therefore, in the present exemplary embodiment, an interpretation is made that a LAN connecting the wireless network equipment 4 in the office system 2 is not installed in the office.

The cloud 8 is a form of a computer network system built by one or a plurality of computers. The cloud 8 in the present exemplary embodiment is connected to the wireless network equipment 4, that is, each of the user terminal 4a and the printer 4b, included in the office system 2 via the Internet 6, and has a relay function of performing relay of a job sent from the user terminal 4a to the printer 4b in a case where the cloud printing service is provided. In the present exemplary embodiment, since the cloud printing service for relaying the print job is described as the cloud service as an example, the printer 4b in the present exemplary embodiment is provided as the job execution apparatus that receives the print job and that executes printing.

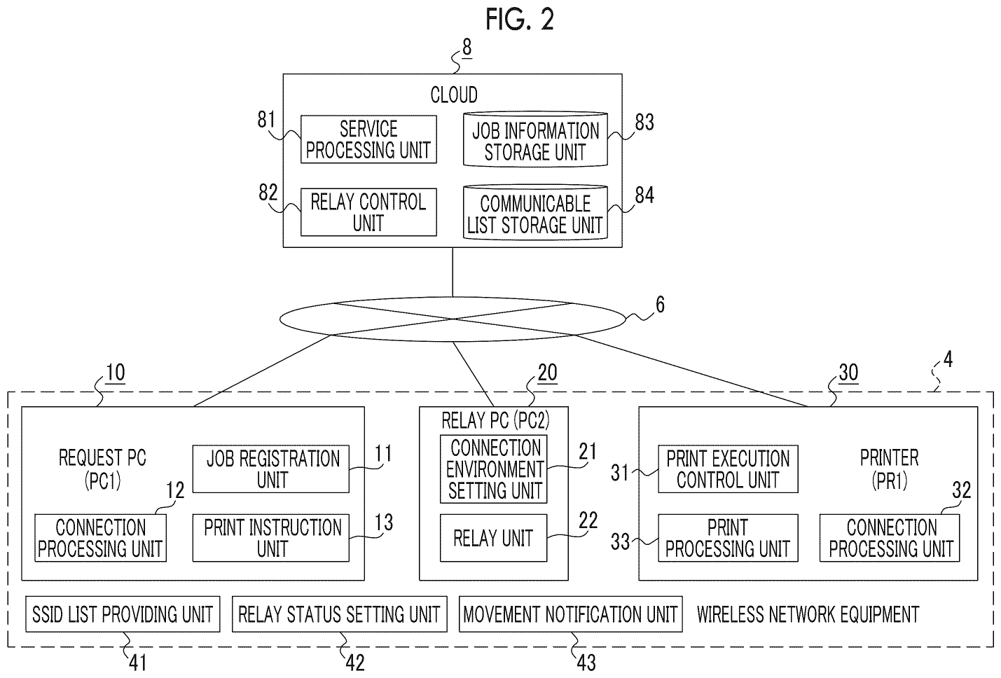

FIG. 2 is a functional block configuration diagram of a cloud printing service system according to the present exemplary embodiment. FIG. 2 shows the cloud 8 and the wireless network equipment 4 each connected to the cloud 8 via the Internet 6. The wireless network equipment 4 in FIG. 2 includes a request PC 10, a relay PC 20, and a printer 30. The “request PC 10” among the request PC 10, the relay PC 20, and the printer 30 refers to the user terminal 4a that requests printing among the user terminals 4a shown in FIG. 1. Further, the “relay PC 20” refers to the user terminal 4a selected by the cloud 8 as the relay equipment for the print job among the user terminals 4a shown in FIG. 1. Of course, since the printer 4b is also a form of the wireless network equipment 4, the printer 4b can be the relay equipment.

For the convenience of description, in FIG. 2, the user terminal 4a having the name “PC1” is the request PC 10, and the user terminal 4a having the name “PC2” is selected as the relay equipment by the cloud 8 and serves as the relay PC 20. Further, the printer 4b having the name “PR1” is selected as the printer 30 executing the print job by the user of the request PC 10.

The cloud 8 includes a service processing unit 81, a relay control unit 82, a job information storage unit 83, and a communicable list storage unit 84. Constituents not used in the description of the present exemplary embodiment are not illustrated in the drawings. The service processing unit 81 executes processing related to the cloud printing service. The service processing unit 81 in the present exemplary embodiment executes processing control related to the cloud printing, such as management of the print job or control of execution of the job. As will be described in detail later, the cloud 8 in the present exemplary embodiment causes any of the user terminals 4a (relay equipment, that is, relay PCs 20) to perform the relay of the print job transmitted from the request PC 10 to the printer 4b, and the relay control unit 82 performs various processing or control related to print the relay of the print job, such as generation of a communicable list, selection of the relay equipment, and setting processing for performing the relay of the print job in addition to the relay function included in the cloud 8.

The job information storage unit 83 stores job information sent from the request PC 10. The job information may be the same as in the related art. In the communicable list storage unit 84, a list of other wireless network equipment 4 (“SSID list” described below) to which each wireless network equipment 4 is capable of wireless connection under WiFi is collected, and the communicable list, which is generated by aggregating the collected SSID lists by the relay control unit 82, is stored. The communicable list will be described together with the description of the operation.

Each of the constituents 81 to 82 in the cloud 8 is implemented through a cooperative operation between one or a plurality of computers included in the cloud 8 and a program operated by a CPU mounted on the computer. Further, each of the storage units 83 to 84 is implemented by a memory such as an HDD mounted on the cloud 8 or a RAM.

The wireless network equipment 4 includes an SSID list providing unit 41, a relay status setting unit 42, and a movement notification unit 43. That is, the constituents 41 to 43 are provided in common to the user terminal 4a and the printer 4b. Constituents not used in the description of the present exemplary embodiment are not illustrated in the drawings.

The SSID list providing unit 41 generates an SSID list in response to a request from the cloud 8 and returns the SSD list. The service set identifier (SSID) is an identification name of an access point in WiFi. The SSID list includes the SSIDs of the wireless network equipment 4 capable of wireless connection at a time point of the request from the cloud 8. That is, the SSID list providing unit 41 makes a notification of the wireless network equipment 4 capable of wireless connection to the host equipment at a current time point by providing the SSID list to the cloud 8. In the present exemplary embodiment, for the convenience of description, the name of the wireless network equipment 4 shown in FIG. 1, such as “PC1” or “PR1”, is also used as the SSID.

The relay status setting unit 42 transmits information for allowing or rejecting the selection of the host equipment as the relay equipment to the cloud 8. In a case where a notification is made that an installation position of the host equipment is moved, the movement notification unit 43 notifies the cloud 8 of the fact that the host equipment is moved.

Each of the constituents 41 to 43 in the wireless network equipment 4 is implemented through a cooperative operation between a computer constituting the wireless network equipment 4 and a program operated by a CPU mounted on the computer. More specifically, functions provided by the constituents 41 to 43 are implemented by the wireless network equipment 4 by installing an application that implements a cloud printing function in the wireless network equipment 4.

The request PC 10 includes a job registration unit 11, a connection processing unit 12, and a print instruction unit 13. Constituents not used in the description of the present exemplary embodiment are not illustrated in the drawings.

The job registration unit 11 registers the information related to the print job, which is included in the request PC 10, in the cloud 8 as job information. In the present exemplary embodiment, since the job is not relayed even in a case where the cloud 8 has the relay function of the job, the request PC 10 does not transmit data, which is an actual object of the print job, to the cloud 8. The connection processing unit 12 performs processing for wirelessly connecting with the relay PC 20 under the control of the cloud 8. The print instruction unit 13 instructs the printer 30 to execute printing by transmitting the print job. However, in the present exemplary embodiment, the print job to be transmitted to the printer 30 is relayed to the relay PC 20.

Each of the constituents 11 to 13 in the request PC 10 is implemented through a cooperative operation between a computer forming the request PC 10 and a program operated by a CPU mounted on the computer. More specifically, each function provided by each of the constituents 11 to 13 is implemented by the request PC 10 by installing an application that implements the cloud printing function in the request PC 10.

The relay PC 20 includes a connection environment setting unit 21 and a relay unit 22. Constituents not used in the description of the present exemplary embodiment are not illustrated in the drawings. The connection environment setting unit 21 performs settings for operating the host equipment as the relay equipment in response to an instruction from the cloud 8. The relay unit 22 performs the relay of the print job by transmitting the print job, which is sent from the request PC 10, to the printer 30.

Each of the constituents 21 to 22 in the relay PC 20 is implemented through a cooperative operation between a computer forming the relay PC 20 and a program operated by a CPU mounted on the computer. More specifically, each function provided by each of the constituents 21 to 22 is implemented by the relay PC 20 by installing an application that implements the cloud printing function in the relay PC 20.

By the way, any of the user terminals 4a operates as the request PC 10 by causing the printer 4b to execute printing by using the cloud printing function. Further, any of the user terminals 4a operates as the relay PC 20 by being selected as the relay equipment in a case where the cloud 8 provides the cloud printing service. Therefore, each user terminal 4a may operate as the request PC 10 or the relay PC 20. More specifically, there is a case where the user terminal 4a operates as the relay PC 20 for other wireless network equipment 4 in addition to operating as the request PC 10. Further, the user terminal 4a that operates as the relay PC 20 becomes the request PC 10 in a case where the printer 4b executes printing by using the cloud printing function. That is, by installing an application that implements the cloud printing function, each user terminal 4a can perform the functions of the constituents 11 to 13 in the request PC 10 and the constituents 21 to 22 in the relay PC 20 in addition to the functions provided by the constituents 41 to 43 included in the wireless network equipment 4. The application that implements the cloud printing function is installed in all the user terminals 4a. That is, the printer 4b can also be the relay equipment.

The printer 30 includes a print execution control unit 31, a connection processing unit 32, and a print processing unit 33. Constituents not used in the description of the present exemplary embodiment are not illustrated in the drawings.

The print execution control unit 31 performs control of the execution of the print job. The connection processing unit 32 performs processing for wirelessly connecting with the relay PC 20 under the control of the cloud 8. The print processing unit 33 performs printing by executing the print job.

Each of the constituents 31 to 33 in the printer 30 is implemented through a cooperative operation between a computer mounted on the printer 30 and a program operated by a CPU mounted on the computer. More specifically, each function provided by each of the constituents 31 to 33 is implemented by the printer 30 by installing an application that implements the cloud printing function in the printer 30.

Further, the program used in the present exemplary embodiment may be not only provided by a communicator but also provided by storing the program in a computer readable recording medium such as a USB memory. The programs provided from the communicator or the recording medium are installed in the computer, and the CPU of the computer sequentially executes the programs to implement various processes.

Although the wireless network equipment 4 constituting a “cloud printing system” in the present exemplary embodiment is described as being configured with a single apparatus as an example, the wireless network equipment 4 may be configured with a plurality of apparatuses. Further, although the cloud 8 is generally configured with a plurality of apparatuses, the cloud 8 may be configured with a single apparatus.

As described above, in the present exemplary embodiment, the cloud printing service is provided as the cloud service. The cloud printing is generally executed as follows.

That is, the cloud 8 accumulates print job information related to the print job to be executed, which is transmitted from any of the user terminals 4a. In the cloud printing in the related art, the print job is also acquired at this time, but the print job is not acquired in the present exemplary embodiment. The user of the user terminal 4a moves to an installation position of the printer 4b where the user wants to execute printing and logs in to the printer 4b, and performs a predetermined operation on an operation panel to display a list of the print jobs, which are registered by the user in the cloud 8, on the operation panel. Thereafter, the print job to be executed from the displayed list is selected. In response to this user operation, the printer 4b acquires the print job from the cloud 8 and executes printing.

In the case of focusing on a flow of the print job in the cloud printing described above, the print job is sent from the user terminal 4a to the printer 4b via the cloud 8. In other words, the cloud 8 relays the print job that is transmitted from the user terminal 4a to the printer 4b. Therefore, since the print job is transmitted to the printer 4b via the Internet 6, the cloud 8, and the Internet 6 again, a consideration is made that relatively long time is required to finish printing as compared with a case where the print job is transmitted and received within the office system 2 between the user terminal 4a and the printer 4b.

Therefore, in the present exemplary embodiment, in a case where the user performs printing by using the cloud printing service, by enabling the print job to be transmitted from the user terminal 4a to the printer 4b without passing through the cloud 8, the time from when printing instruction is performed by operating the printer 4b by the user until printing is ended can be relatively shortened as compared with a case where the print job is transmitted via the cloud 8. Hereinafter, an operation in a case where the user performs printing by using the cloud printing service in the present exemplary embodiment will be described.

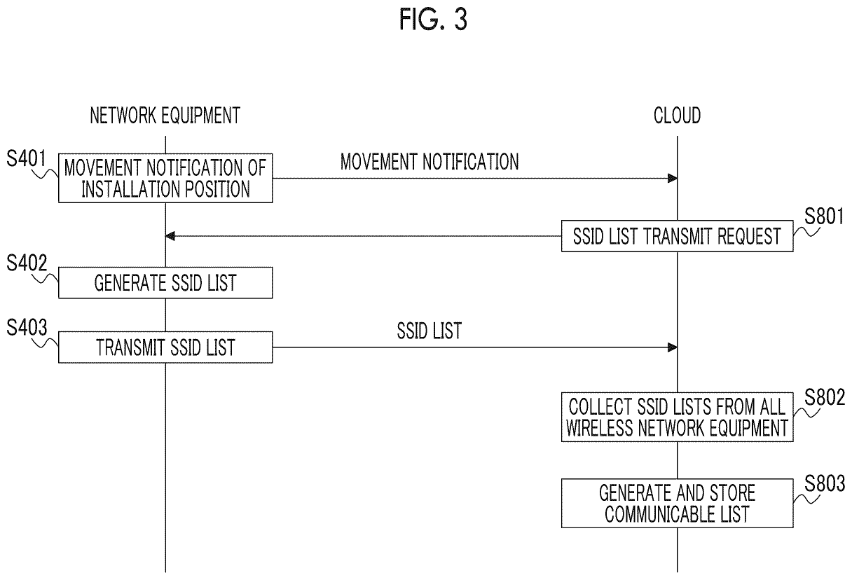

First, processing to be executed before using the cloud printing service will be described with reference to the sequence diagram shown in FIG. 3.

The processing shown in FIG. 3 is processing of generating the communicable list by the cloud 8. The communicable list is the communication relationship information indicating a communicable relationship between the wireless network equipment 4 in the office. In order to generate the communicable list, the relay control unit 82 in the cloud 8 transmits an SSID list transmission request to each of the wireless network equipment 4 included in the office system 2 (step S801). The cloud 8 understands the wireless network equipment 4 as a transmission destination of the SSID list transmission request on a contract of the cloud printing service. The processing in step S401 shown in FIG. 3 will be described later.

In a case where the SSID list transmission request, which is transmitted from the cloud 8, is received, the SSID list providing unit 41 in each wireless network equipment 4 causes the access point to output a WiFi radio wave. The “WiFi radio wave” referred to here is a wireless signal for searching for a communication partner capable of wireless connection based on the WiFi, and the wireless signal includes the SSID of the host equipment. Each wireless network equipment 4 can collect the SSIDs of the wireless network equipment 4 capable of wireless connection at the current time point, that is, at a transmission request time point from the cloud 8 by receiving the WiFi radio waves transmitted from other wireless network equipment 4, and can generate the SSID list including the collected SSIDs (step S402). That is, the SSID list is the list information of the wireless network equipment 4 capable of wireless communication.

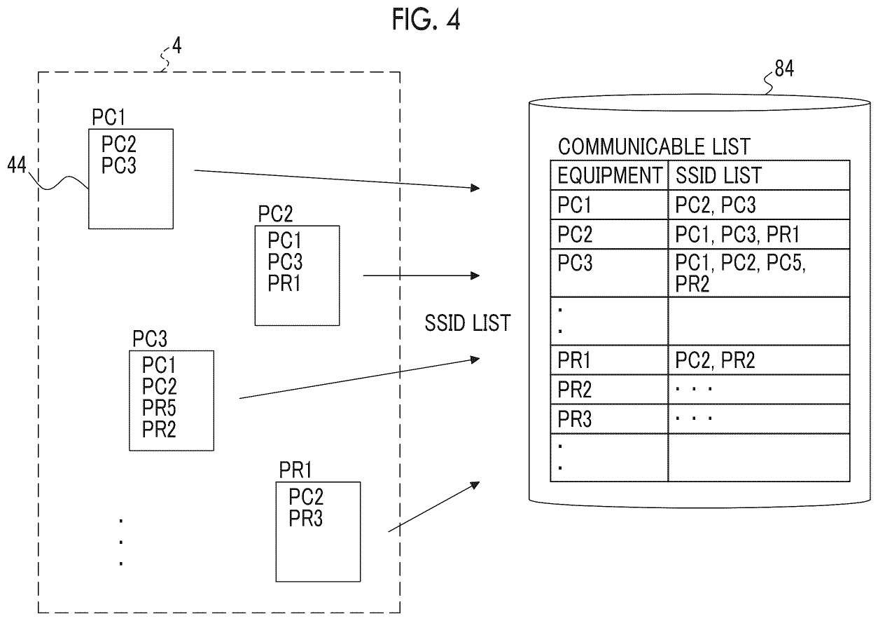

FIG. 4 is a diagram schematically showing generation processing of the communicable list. In FIG. 4, for example, in a case of referring to an SSID list 44 in the wireless network equipment 4 having the name “PC1” (hereinafter, referred to as “equipment PC1” and the same applies to other wireless network equipment 4), since the equipment PC1 is able to receive the WiFi radio waves output from the equipment PC2 and the equipment PC3, a consideration can be made that wireless connection is possible between the equipment PC1, and the equipment PC2 and PC3, and thereby wireless communication is possible between the equipment PC1, and the equipment PC2 and PC3.

The SSID list providing unit 41 in each wireless network equipment 4 transmits the generated SSID list to the cloud 8 (step S403).

The relay control unit 82 collects the SSID lists returned from all the wireless network equipment 4 in response to the transmitted SSID list transmission request (step S802), generates a communicable list including the collected SSID lists, and stores the communicable list in the communicable list storage unit 84 (step S803). Further, in a case where the wireless network equipment 4 that does not return the SSID list within predetermined time is present, the wireless network equipment 4 may be ignored.

FIG. 4 shows an example of a data configuration of the communicable list generated by using the above processing. The communicable list is set by associating the name of each wireless network equipment 4 with the SSID list acquired from the corresponding wireless network equipment 4. That is, the relay control unit 82 generates a bundle of SSID lists acquired from each wireless network equipment 4 as the communicable list.

In the present exemplary embodiment, the processing described above except for step S401 is executed before the print request is made. Further, the communicable list generation processing may be periodically repeated, as required.

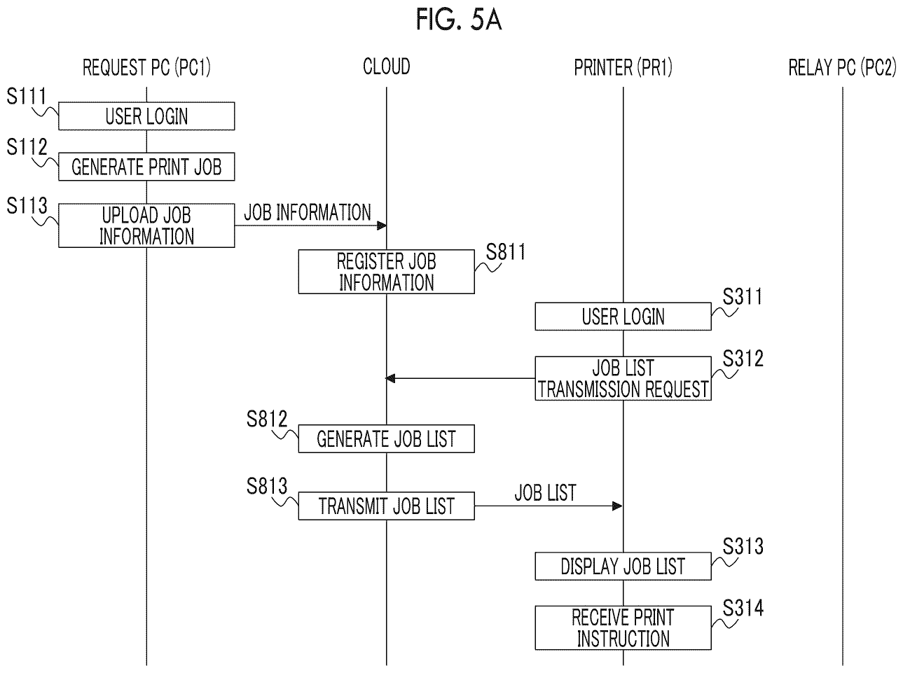

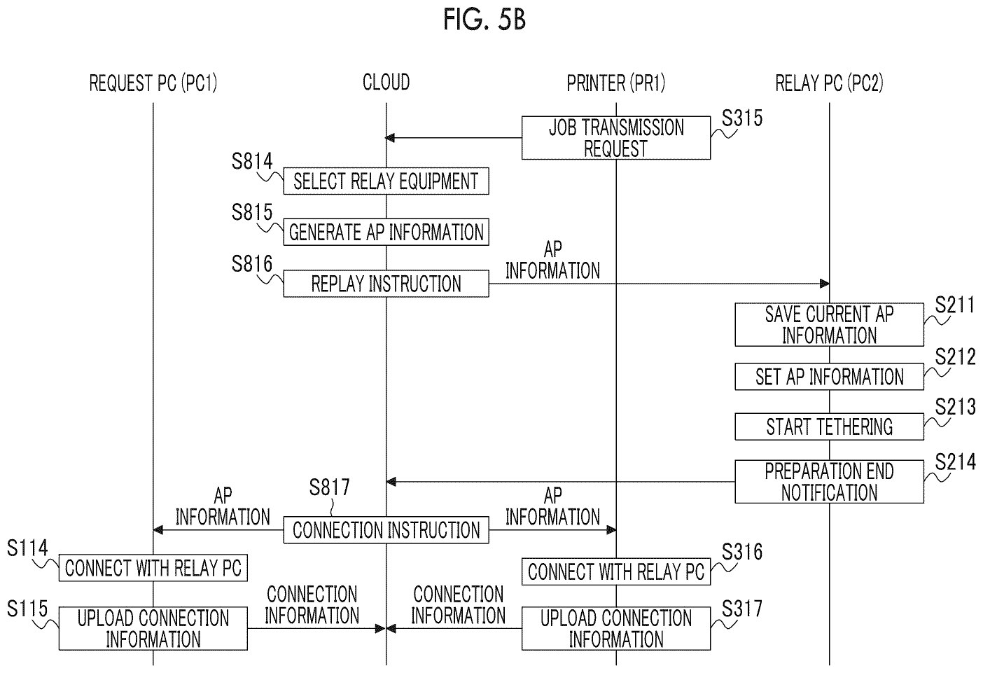

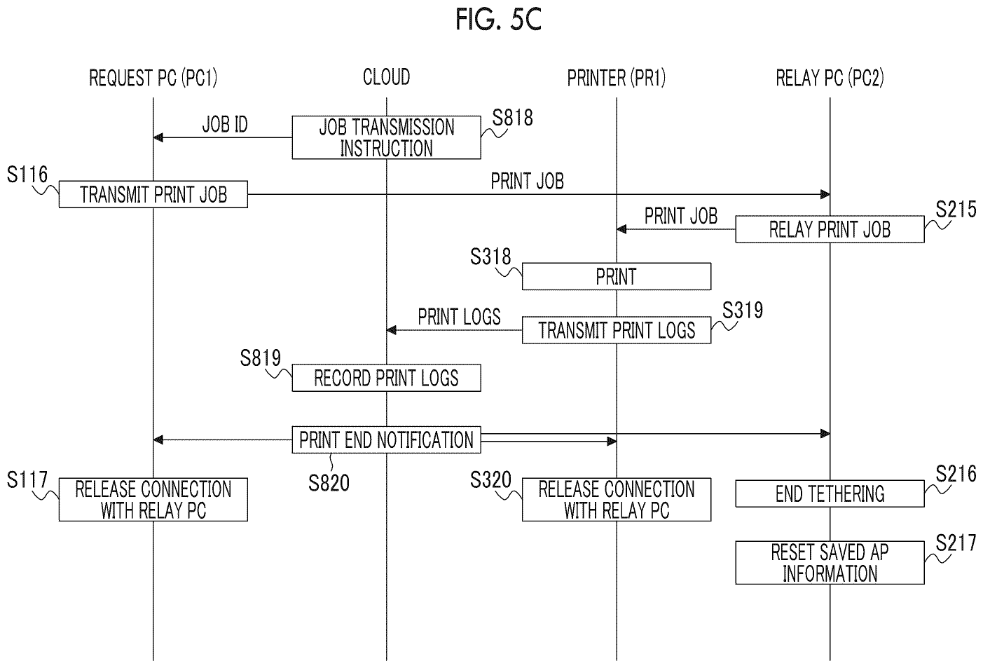

Subsequently, the cloud printing processing in the present exemplary embodiment will be described with reference to the sequence diagrams shown in FIGS. 5A to 5C.

In a case where a user of any of the user terminals 4a shown in FIG. 1 performs printing by using any of the printers 4b, although the user terminal 4a corresponds to the request PC 10 shown in FIG. 2 for the first time, and the printer 4b that is selected by the user for printing corresponds to the printer 30 shown in FIG. 2 for the first time, for the convenience of description, the user terminal 4a of the user who performs printing from the beginning is referred to as the “request PC 10”, and the printer 4b used by the user is referred to as the “printer 30”, respectively.

In a case where the user logs in to the request PC 10 (step S111) and generates a print job (step S112), job registration is requested by uploading job information related to the print job to the cloud 8 (step S113).

In the cloud 8, in a case where the job information is transmitted from the request PC 10, the service processing unit 81 registers the job information in the job information storage unit 83 (step S811). The job information includes a user ID for identifying the user who is the registration request source.

After confirming that the job information is registered in the cloud 8, the user of the request PC 10 moves to an installation position of the printer 30 to be used for printing and logs in to the printer 30 (step S311). Subsequently, the user performs a predetermined operation for displaying the job list on an operation panel of the printer 30. The print execution control unit 31 in the printer 30 requests the cloud 8 to transmit the job list in response to the user operation (step S312). The transmission request includes a login ID of a user logged in to the printer 30, that is, a user ID of the user.

In the cloud 8, in a case where the transmission request of the job list is transmitted from the printer 30, the service processing unit 81 compares the user ID included in the transmission request with the user ID included in each piece of job information registered in the job information storage unit 83, extracts the job information that matches the user ID from the job information storage unit 83, and generates the job list (step S812). Thereafter, the service processing unit 81 transmits the generated job list to the printer 30 (step S813).

In a case where the job list is returned from the cloud 8 in response to the job list transmission request, the print execution control unit 31 displays the job list on the operation panel (step S313). The user instructs the printer 30 to print by referring to the displayed job list and selecting the print job that the user wants to execute from the list. In a case where the print execution control unit 31 receives the selected print job as a print instruction by the user (step S314), the print execution control unit 31 requests the cloud 8 to transmit the print job (step S315).

The series of processing procedures up to a point where the above-described user requests printing by operating the printer 30 may be the same as in the related art.

In the cloud 8, in a case where the transmission request of the print job is sent from the printer 30, the service processing unit 81 in the related art transmits the print job, which is stored internally, to the printer 30, but in the present exemplary embodiment, the print job from the request PC 10 is not stored because the print job is not relayed to the cloud 8.

By the way, since each wireless network equipment 4 includes the access point, the print job may be directly transmitted and received between the wireless network equipment 4, that is, between the request PC 10 and the printer 30. However, in the present exemplary embodiment, a state is assumed in which wireless communication is not possible between the request PC 10 and the printer 30, for example, the request PC 10 and the printer 30 are in a positional relationship where the request PC 10 and the printer 30 are so far apart that the radio waves output by the access point cannot be transmitted and received. In this case, the request PC 10 cannot directly transmit the print job to the printer 30.

Therefore, in the present exemplary embodiment, the cloud 8 selects relay equipment (the relay PC 20 shown in FIG. 2) that relays the print job from the request PC 10 to the printer 30, and the print job is indirectly delivered to the printer 30 by relaying the print job to the selected relay equipment. In a case where the request PC 10 can directly transmit the print job to the printer 30, the print job may be transmitted directly from the request PC to the printer 30.

The relay control unit 82 in the cloud 8 selects the relay equipment as follows (step S814). First, the relay control unit 82 searches for the wireless network equipment 4 that is commonly included in both the SSID lists acquired from each of the request PC 10, which is an execution request source of the print job, and the printer 30, which is an execution destination of the print job, by referring to the communicable list stored in the communicable list storage unit 84. According to the setting example of the communicable list shown in FIG. 4, only the equipment PC2 is included in the SSID lists of both the equipment PC1, which is the request PC 10, and the equipment PR2, which is the printer 30. Therefore, the relay control unit 82 selects the equipment PC2 as the relay equipment (relay PC20 shown in FIG. 2) from among the wireless network equipment 4.

According to the setting example of the communicable list shown in FIG. 4, the equipment PC3 included in the SSID list of the equipment PC1 is not selected as the relay equipment because the equipment PC3 is not included in the SSID list of equipment PR1. Similarly, the equipment PR2 included in the SSID list of the equipment PR1 is not selected as the relay equipment because the equipment PR2 is not included in the SSID list of equipment PC1.

Further, although FIG. 4 shows a setting example in which only one relay equipment is selected for the convenience, a case can be also assumed in which the SSID lists of both the request PC 10 and the printer 30 include a plurality of common wireless network equipment 4. In this case, for example, a predetermined selection criterion, which uses a type, performance, relay record, and the like of the wireless network equipment 4 as a determination index, may be set in advance so that one wireless network equipment 4 can be selected. On the contrary, a case can be also assumed in which the SSID lists of both the request PC 10 and the printer 30 do not include any common wireless network equipment 4. This case will be described later.

In a case where the relay equipment can be selected, the relay control unit 82 generates access point (AP) information to be set in the relay equipment (step S815). The access point information is configured with a set of an SSID and a password used in a case where an operation is made as the relay equipment. As the password, a one-time password as the designated equipment identification information is used. By transmitting the access point information to the wireless network equipment 4 selected as the relay equipment without performing the relay of the print job, the relay control unit 82 instructs the selected wireless network equipment 4 to operate as the relay equipment (step S816).

As described above, the equipment PC2 corresponds to the relay PC 20 as the relay equipment. By receiving the access point information transmitted from the cloud 8, the equipment PC2, which operates as the relay PC 20, knows that the host equipment is selected as the relay equipment. In this case, the connection environment setting unit 21 temporarily saves the access point information consisting of the SSID and password currently set in the host equipment in a predetermined storing location (step S211), and then sets the access point information received from the cloud 8 as the access point information of the host equipment (step S212). As a result, the relay PC 20 starts tethering for the request PC 10 and the printer 30 (step S213). In a case where the relay PC 20 starts tethering, the connection environment setting unit 21 notifies the cloud 8 that preparation for operating as the relay equipment is ended (step S214).

In the cloud 8, in a case where preparation end notification is sent from the relay PC 20, the relay control unit 82 instructs each of the request PC 10, which is an execution request source of the print job, and the printer 30, which is an execution destination of the print job, to establish a wireless connection with the relay PC 20 (step S817). The instruction includes the same access point information as the access point information sent to relay PC 20 in step S816. The access point information provided by the cloud 8 is equipment identification information of the relay PC 20 necessary for each of the request PC 10 and the printer 30 to establish a wireless connection with the relay PC 20.

As described above, in the present exemplary embodiment, since a one-time password is used for the access point information, there is no need to notify the request PC 10, which is an execution request source of the job, and the printer 30, which is an execution destination of the job, of the access point information used by the relay PC 20. Therefore, although there is no particular limitation, the relay PC 20 is preferable from the viewpoint of security, for example. Of course, the access point information used by the relay PC 20 may be used as it is. In this case, in step S816, a notification for instructing the operation as the relay equipment may be sent. Further, in step S816, the relay control unit 82 acquires the access point information used by the relay PC 20 and sends the access point information to the request PC 10 and the printer 30. The relay PC 20 provides the access point information of the host equipment to the cloud 8 by, for example, including the preparation end notification.

In a case where the connection instruction is sent to the request PC 10, the connection processing unit 12 is wirelessly connected by requesting a connection to the relay PC 20 specified in the access point information included in the connection instruction (step S114). In this way, in a case where a wireless communication line is established between the request PC 10 and the relay PC 20, the connection processing unit 12 uploads connection information including an IP address of the host equipment to the cloud 8 (step S115). By processing the connection processing unit 32 of the printer 30 in the same manner, the printer 30 is wirelessly connected to the relay PC 20 (step S316), and then uploads the connection information including the IP address of the host equipment to the cloud 8 (step S317).

In the cloud 8, in a case where a confirmation is made that the request PC 10 and the printer 30 are each wirelessly connected to the relay PC 20 by the relay control unit 82 receiving the connection information from both sides, the service processing unit 81 instructs the request PC 10 to transmit the print job (step S818). The transmission instruction includes a job ID, which specifies the print job selected by the user from the job list displayed in step S313, and the connection information of the printer 30.

The print instruction unit 13 in the request PC 10 transmits the print job, which corresponds to the job ID included in the transmission instruction and to be transmitted to the printer 30 specified from the connection information, toward the relay PC 20 in response to the transmission instruction from the cloud 8 (step S116).

In a case where the print job to be transmitted to the printer 30 from the request PC 10 is transmitted, the relay unit 22 in the relay PC 20 transmits the print job to the printer 30. In this way, the relay PC 20 relays the print job (step S215).

In a case where a print job is transmitted from the request PC 10 via the relay PC 20, the print processing unit 33 in the printer 30 executes printing based on the print job (step S318). In a case where the execution of printing is ended, the print processing unit 33 notifies the cloud 8 that the printing is ended by transmitting print logs to the cloud 8 (step S319).

As described above, the printing is executed in response to a print instruction provided by the user selecting the print job from the job list displayed on the operation panel of the printer 30. In the present exemplary embodiment, the print job is transmitted and received in the office system 2 without passing through the cloud 8. Therefore, since the print job is not transmitted and received via the Internet 6 and the cloud 8, time from when the print instruction is provided from the user to the end can be reduced. Further, even in a case where the request PC 10 cannot directly transmit the print job to the printer 30, since the print job is relayed to any of the wireless network equipment 4 in the office system 2, the printer 30 can execute the printing.

By the way, FIG. 4 shows a setting example of the communicable list in which the equipment PC2 is selected as the relay equipment. However, as described above, a case can be also assumed in which the wireless network equipment 4, which is commonly set in each SSID list of the request PC 10 and the printer 30, is not present. In this case, the relay control unit 82 in the cloud 8 attempts to further analyze the communicable list and select a plurality of relay equipment.

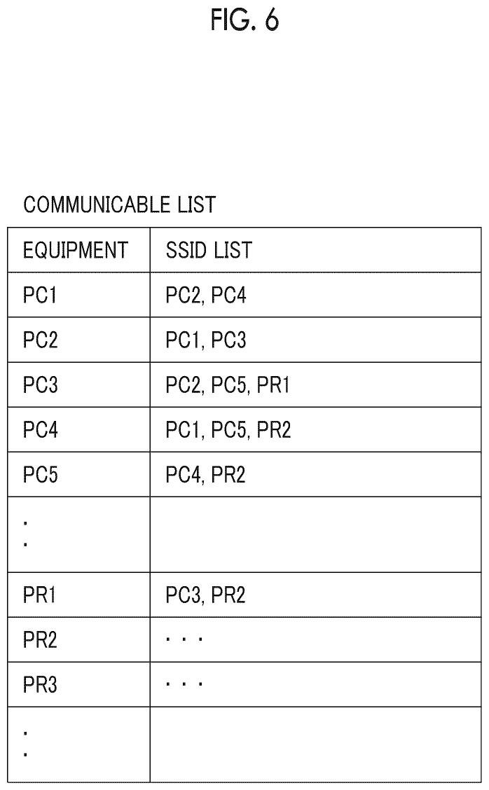

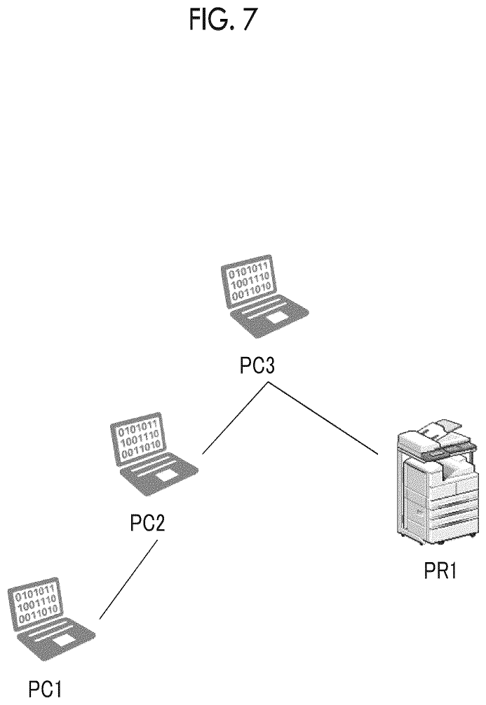

FIG. 6 is a diagram showing another setting example of the communicable list in the present exemplary embodiment. In the same manner as described above, an assumption is made that the equipment PC1 is the request PC 10 and the equipment PR1 is the printer 30. According to the setting example shown in FIG. 6, the common wireless network equipment 4 is not present in each SSID list of the equipment PC1 and the equipment PR1. In this case, the relay control unit 82 checks whether relay is possible by coordinating a plurality of relay equipment by repeating a selection method of the relay equipment described above. According to the setting example of the communicable list shown in FIG. 6, the equipment PC3 is present as the common wireless network equipment 4 in each SSID list of the equipment PC2 and the equipment PR1 among the equipment PC2 and the equipment PC4 included in the SSID list of the equipment PC1. Therefore, the relay control unit 82 selects the equipment PC2 and the equipment PC3 as the relay equipment that relays the print job from the equipment PC1. In the present exemplary embodiment, the print job may be relayed by selecting a plurality of relay equipment in this way. FIG. 7 shows a conceptual diagram in a case where the equipment PC2 and the equipment PC3 are selected as the plurality of relay equipment, and relay is performed. As shown in FIG. 7, the print job of the equipment PC1, which is an execution request source of printing, is relayed by the equipment PC2 and the equipment PC3 selected as the relay equipment, and is transmitted to the equipment PR1, which is an execution destination of the printing.

Next, a function of the relay status setting unit 42 included in the wireless network equipment 4 will be described.

In the present exemplary embodiment, the cloud 8 selects the relay equipment by referring to the communicable list, but the relay equipment is selected without considering the current status of the wireless network equipment 4. Considering the current status, for example, in a case where high-load processing is being executed or the wireless network equipment 4 needs to avoid communication with other wireless network equipment 4 for security reasons at the current time point, a case can be assumed in which the wireless network equipment 4 is in a state where the equipment does not want to operate as the relay equipment. Further, a case may be assumed in which the user does not want to use the host equipment as the relay equipment. Further, in a case where certain wireless network equipment 4 is already selected and operates as the relay equipment, and in a case where another wireless network equipment 4 is further selected as the relay equipment and tethering is performed redundantly, a security problem may occur. In that case, setting or managing the access point information may become difficult.

Therefore, in the present exemplary embodiment, in consideration of the current situation of the wireless network equipment 4, a function for allowing the wireless network equipment 4 to avoid operating as the relay equipment may be provided.

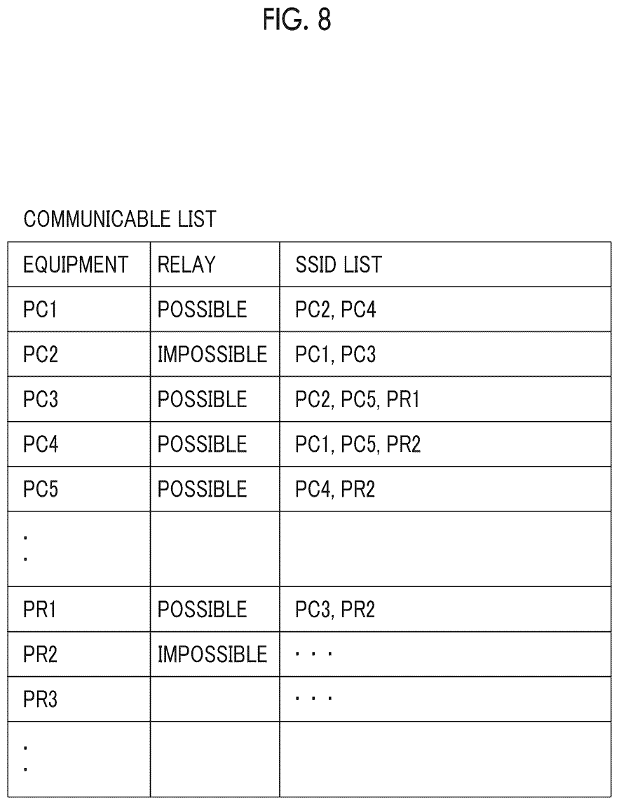

FIG. 8 is a diagram showing another data configuration example of the communicable list in the present exemplary embodiment. In the communicable list shown in FIG. 8, relay information (“relay” shown in FIG. 8) indicating a possibility is further associated with the name of the wireless network equipment 4. The relay information is flag information, and “possible” is set in a case where selection is possible as the relay equipment, and “impossible” is set in a case where selection is not possible as the relay equipment. The initial value may be “possible”.

As illustrated above, in a case where the wireless network equipment 4 is in a status in which the equipment needs to avoid being selected as the relay equipment, the relay status setting unit 42 in the wireless network equipment 4 transmits relay impossible information indicating the above fact to the cloud 8. In a case where the relay impossible information is transmitted from any of the wireless network equipment 4, the relay control unit 82 in the cloud 8 sets the relay information corresponding to the wireless network equipment 4 in the communicable list to “impossible”. As a result, in a case where the relay equipment is selected in step S814 shown in FIG. 5B, the relay control unit 82 refers to the relay information and excludes the wireless network equipment 4, which is set as “impossible”, from a selection candidate of the relay equipment.

By the way, as a predetermined timing at which the relay status setting unit 42 transmits the relay impossible information to the cloud 8, transmission may be performed automatically, or transmission may be performed in response to an instruction from the user. For the former case, for example, a predetermined condition that becomes a factor that makes the relay impossible, such as a case where the host equipment is already selected as the relay equipment, or a case where a communication load on the host equipment is equal to or larger than a predetermined threshold value, is set in advance. The relay status setting unit 42 may perform processing such that the relay impossible information is automatically transmitted at a timing at which a determination can be made that the host equipment currently corresponds to a status in which the predetermined condition is satisfied. For the latter case, processing may be performed such that the relay impossible information is transmitted to the cloud 8 in response to a predetermined manual operation by the user. Further, the relay impossible information may be included in the SSID list to be transmitted in step S403 and sent.

Further, contrary to the relay impossible information, in a case where the relay information in the communicable list is currently set to “impossible”, in order to unset the impossibility, the relay status setting unit 42 may transmit relay possible information indicating the fact that the relay is possible to the cloud 8. As the timing at which the relay possible information is transmitted, contrary to the relay impossible information, processing may be performed such that the relay possible information is automatically transmitted in a case where the predetermined condition that becomes a factor that makes the relay impossible is resolved, or processing may be performed such that the relay possible information is transmitted to the cloud 8 in response to a predetermined manual operation by the user.

As described above, the relay status setting unit 42 transmits the relay impossible information or the relay possible information as the relay information to the cloud 8 according to a current status of the host equipment. In a case where the relay information, which is transmitted from any of the wireless network equipment 4, is acquired, the relay control unit 82 sets the relay information corresponding to the wireless network equipment 4 in the communicable list to “possible” or “impossible”.

Here, step S401 in the communicable list generation processing shown in FIG. 3 will be described. The movement notification unit 43 generally executes the processing in step S401.

In step S402 in FIG. 3, each wireless network equipment 4 generates the SSID list at a time point when transmission of the SSID list is requested from the cloud 8. As described above, the SSID list includes the SSIDs of other wireless network equipment 4 capable of wireless connection at the time point when the transmission request is made. Capable of wireless connection to other wireless network equipment 4 means that other wireless network equipment 4 are installed within a range in which WiFi radio waves transmitted from the host equipment can reach.

Although not specifically mentioned in the above description, an assumption is basically made that the wireless network equipment 4 is not moved from the current installation position. That is, even in a case where the request PC 10 is portable, a description is made that the user of the request PC 10 does not move to the vicinity of the printer 30 capable of wireless connection at the time of the print request. However, the wireless network equipment 4 may be moved due to some reason such as a change of affiliation. In a case where the installation position of the host equipment or other wireless network equipment 4 is moved, there is a possibility that the WiFi radio waves will not reach other wireless network equipment 4 installed within a reachable range in which WiFi radio waves transmitted from the host equipment can reach. In this case, in settings of the communicable list maintained and managed in the cloud 8, in other words, the communicable list generated on the assumption that wireless connection is possible between other wireless network equipment 4, there is a possibility that the relay equipment may not be selected correctly.

Therefore, in the present exemplary embodiment, there is provided a function for avoiding the occurrence of such a defective status in advance. Specifically, in a case where a detection is made that an installation place of the host equipment has been moved, the movement notification unit 43 provides a notification of a fact that the installation position has been moved (step S401). The movement of the installation position can be detected by, for example, an acceleration sensor mounted on each wireless network equipment 4.

In a case where the notification of a fact that the movement has been performed is received, the relay control unit 82 in the cloud 8 transmits the SSID list transmission request to each wireless network equipment 4 (step S801). Since the subsequent processing has already been described, the description thereof will be omitted.

As described above, as the predetermined timing at which the SSID list transmission request is transmitted, the time when the movement of the installation position is notified from the wireless network equipment 4 can be used as described here, in addition to providing the cloud printing service mentioned above.

In the present exemplary embodiment, since the communicable list can be regenerated at the timing at which the notification of a fact that the installation position is moved is received from any of the wireless network equipment 4, a situation in which the relay equipment cannot be selected correctly can be avoided in advance.

In the present exemplary embodiment, a case where the cloud service provided by the cloud 8 is a cloud printing service, has been described as an example. As a result, a case where the job executed by the job execution system is a print job, and the job execution apparatus is a printing apparatus, has been described. However, the cloud service is not limited to the cloud printing service. That is, in a case where a system provides a cloud service having a function of relaying a job from an information processing apparatus, which requests a job execution apparatus to execute a job other than a print job, to the job execution apparatus, the job execution service system described in the present exemplary embodiment can be applied.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

A job execution service system comprising:
a cloud side processor that is connected to each of an information processing apparatus and a job execution apparatus, which is installed in a local area as wireless network equipment having a wireless communication function based on a predetermined wireless communication system, via the Internet and that is configured to perform relay of a job sent from the information processing apparatus to the job execution apparatus in a case where a cloud service is provided,
wherein the cloud side processor is configured to:
   select relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area;
   provide equipment identification information necessary for wireless connection with the relay equipment to the execution request source and the execution destination of the job; and
   instruct the relay equipment to perform the relay of the job from the execution request source to the execution destination of the job instead of performing the relay of the job by the cloud side processor.

(((2)))

The job execution service system according to (((1))), wherein the cloud side processor is configured to:
acquire, from each of the wireless network equipment, list information of wireless network equipment with which the corresponding wireless network equipment is capable of wireless communication; and store the acquired list information as the communication relationship information.

(((3)))

The job execution service system according to (((2))), wherein the cloud side processor is configured to, in a case where the wireless network equipment that is included in both the list information acquired from the execution request source and the execution destination of the job is present, select the corresponding wireless network equipment as the relay equipment.

(((4)))

The job execution service system according to (((2))), wherein the cloud side processor is configured to, in a case where the wireless network equipment that is included in both the list information acquired from the execution request source and the execution destination of the job is not present, select a plurality of relay equipment and cause the selected plurality of relay equipment to sequentially relay the job of the execution request source of the job to the execution destination of the job.

(((5)))

The job execution service system according to (((1))), wherein the cloud side processor is configured to, in a case where relay impossible information is acquired from the wireless network equipment, exclude the corresponding wireless network equipment from a selection candidate of the relay equipment.

(((6)))

The job execution service system according to (((1))), wherein the cloud side processor is configured to:
request each of the wireless network equipment to transmit list information of wireless network equipment with which the corresponding wireless network equipment is capable of wireless communication, at a predetermined timing; and
generate the communication relationship information including the list information transmitted from each of the wireless network equipment in response to the corresponding request.

(((7)))

The job execution service system according to (((6))), wherein the predetermined timing is a timing at which movement of an installation position is notified from any of the wireless network equipment.

(((8)))

The job execution service system according to (((1))), wherein a processor included in the relay equipment is configured to:
in a case where equipment identification information necessary for wireless connection with the wireless network equipment that is a relay source and a relay destination of the job is transmitted from the cloud side processor as designated equipment identification information, save equipment identification information currently being set as equipment identification information of host equipment and set the designated equipment identification information as the equipment identification information of the host equipment;
relay the job sent from the relay source of the job to the relay destination of the job; and
in a case where relay is ended, reset the saved equipment identification information as the equipment identification information of the host equipment.

(((9)))

The job execution service system according to any one of (((1))) to (((8))),
wherein the cloud service is a cloud printing service, and
the job execution apparatus is a printing apparatus.

(((10)))

A program causing a computer that is connected to each of an information processing apparatus and a job execution apparatus, which is installed in a local area as wireless network equipment having a wireless communication function based on a predetermined wireless communication system, via the Internet and that is configured to perform relay of a job sent from the information processing apparatus to the job execution apparatus in a case where a cloud service is provided, to implement:
a function of selecting relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area;
a function of providing equipment identification information necessary for wireless connection with the relay equipment to the execution request source and the execution destination of the job; and
a function of instructing the relay equipment to perform the relay of the job from the execution request source to the execution destination of the job instead of performing the relay of the job by the computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A job execution service system comprising:
a cloud side processor that is connected to each of an information processing apparatus and a job execution apparatus, which is installed in a local area as wireless network equipment having a wireless communication function based on a predetermined wireless communication system, via the Internet and that is configured to perform relay of a job sent from the information processing apparatus to the job execution apparatus in a case where a cloud service is provided,
wherein the cloud side processor is configured to:
select relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area;
provide equipment identification information necessary for wireless connection with the relay equipment to the execution request source and the execution destination of the job; and
instruct the relay equipment to perform the relay of the job from the execution request source to the execution destination of the job instead of performing the relay of the job by the cloud side processor.

2. The job execution service system according to claim 1, wherein the cloud side processor is configured to:
acquire, from each of the wireless network equipment, list information of wireless network equipment with which the corresponding wireless network equipment is capable of wireless communication; and
store the acquired list information as the communication relationship information.

3. The job execution service system according to claim 2, wherein the cloud side processor is configured to, in a case where the wireless network equipment that is included in both the list information acquired from the execution request source and the execution destination of the job is present, select the corresponding wireless network equipment as the relay equipment.

4. The job execution service system according to claim 2, wherein the cloud side processor is configured to, in a case where the wireless network equipment that is included in both the list information acquired from the execution request source and the execution destination of the job is not present, select a plurality of relay equipment and cause the selected plurality of relay equipment to sequentially relay the job of the execution request source of the job to the execution destination of the job.

5. The job execution service system according to claim 1, wherein the cloud side processor is configured to, in a case where relay impossible information is acquired from the wireless network equipment, exclude the corresponding wireless network equipment from a selection candidate of the relay equipment.

6. The job execution service system according to claim 1, wherein the cloud side processor is configured to:
request each of the wireless network equipment to transmit list information of wireless network equipment with which the corresponding wireless network equipment is capable of wireless communication, at a predetermined timing; and
generate the communication relationship information including the list information transmitted from each of the wireless network equipment in response to the corresponding request.

7. The job execution service system according to claim 6,
wherein the predetermined timing is a timing at which movement of an installation position is notified from any of the wireless network equipment.

8. The job execution service system according to claim 1, wherein a processor included in the relay equipment is configured to:
in a case where equipment identification information necessary for wireless connection with the wireless network equipment that is a relay source and a relay destination of the job is transmitted from the cloud side processor as designated equipment identification information, save equipment identification information currently being set as equipment identification information of host equipment and set the designated equipment identification information as the equipment identification information of the host equipment;
relay the job sent from the relay source of the job to the relay destination of the job; and
in a case where relay is ended, reset the saved equipment identification information as the equipment identification information of the host equipment.

9. The job execution service system according to claim 1,
wherein the cloud service is a cloud printing service, and
the job execution apparatus is a printing apparatus.

10. The job execution service system according to claim 2,
wherein the cloud service is a cloud printing service, and
the job execution apparatus is a printing apparatus.

11. The job execution service system according to claim 3,
wherein the cloud service is a cloud printing service, and
the job execution apparatus is a printing apparatus.

12. The job execution service system according to claim 4,
wherein the cloud service is a cloud printing service, and
the job execution apparatus is a printing apparatus.

13. The job execution service system according to claim 5,
wherein the cloud service is a cloud printing service, and
the job execution apparatus is a printing apparatus.

14. The job execution service system according to claim 6,
wherein the cloud service is a cloud printing service, and
the job execution apparatus is a printing apparatus.

15. The job execution service system according to claim 7,
wherein the cloud service is a cloud printing service, and
the job execution apparatus is a printing apparatus.

16. The job execution service system according to claim 8,
wherein the cloud service is a cloud printing service, and
the job execution apparatus is a printing apparatus.

17. A non-transitory computer readable medium storing a program causing a computer that is connected to each of an information processing apparatus and a job execution apparatus, which is installed in a local area as wireless network equipment having a wireless communication function based on a predetermined wireless communication system, via the Internet and that is configured to perform relay of a job sent from the information processing apparatus to the job execution apparatus in a case where a cloud service is provided, to implement:
a function of selecting relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area;
a function of providing equipment identification information necessary for wireless connection with the relay equipment to the execution request source and the execution destination of the job; and
a function of instructing the relay equipment to perform the relay of the job from the execution request source to the execution destination of the job instead of performing the relay of the job by the computer.

18. A job execution service method of, for each of an information processing apparatus and a job execution apparatus, which is installed in a local area as wireless network equipment having a wireless communication function based on a predetermined wireless communication system, performing relay of a job sent from the information processing apparatus to the job execution apparatus in a case where a cloud service is provided, the job execution service method comprising:
selecting relay equipment, which relays the job sent from the information processing apparatus that is an execution request source of the job to the job execution apparatus that is an execution destination of the job in response to an instruction from a user, from among the wireless network equipment by referring to communication relationship information indicating a communicable relationship between the wireless network equipment in the local area;
providing equipment identification information necessary for wireless connection with the relay equipment to the execution request source and the execution destination of the job; and
instructing the relay equipment to perform the relay of the job from the execution request source to the execution destination of the job instead of performing the relay of the job by host equipment.
